(19) United States
(12) Patent Application Publication
(10) Pub. No.: US 2024/0013948 A1
(43) Pub. Date: Jan. 11, 2024

(54) ELECTRIC WIRE AND MULTICORE CABLE

(71) Applicant: SUMITOMO ELECTRIC INDUSTRIES, LTD., Osaka (JP)

(72) Inventors: Kenji HORI, Tochigi (JP); Nayu YANAGAWA, Osaka (JP)

(21) Appl. No.: 18/347,101

(22) Filed: Jul. 5, 2023

(30) Foreign Application Priority Data
Jul. 11, 2022 (JP) 2022-111410

(51) Int. Cl. H01B 3/00

(52) U.S. Cl. CPC H01B 3/002; H01B 7/02

(57) ABSTRACT

An electric wire includes: a conductor; and an insulator that covers the conductor. The insulator includes a resin material and a first filler. The insulator includes the first filler at a proportion of 10% by mass or more and 40% by mass or less. The first filler is a chemical substance produced from a biological material.

### CROSS-REFERENCE TO RELATED APPLICATIONS

The present application is based on and claims priority to Japanese Patent Application No. 2022-111410 filed on Jul. 11, 2022, the contents of which are incorporated herein by reference in their entirety.

### TECHNICAL FIELD

The following disclosure generally relates to an electric wire and a multicore cable.

### BACKGROUND

Japanese Laid-Open Patent Application Publication No. 2012-099380 discloses an insulated electric wire including a conductor and an insulator that covers the outer periphery of the conductor. In the insulated electric wire, the insulator is made of a resin composition containing biomass-based plastic and vinyl chloride resin.

### SUMMARY

According to an embodiment of the present disclosure, an electric wire includes: a conductor; and an insulator that covers the conductor, wherein the insulator includes a resin material and a first filler, the insulator includes the first filler at a proportion of 10% by mass or more and 40% by mass or less, and the first filler is a chemical substance produced from a biological material.

### BRIEF DESCRIPTION OF THE DRAWINGS

FIG. 1 is a cross-sectional view illustrating an electric wire in a plane perpendicular to the longitudinal direction of the electric wire according to an aspect of the present disclosure; and

FIG. 2 is a cross-sectional view illustrating a multicore cable in a plane perpendicular to the longitudinal direction according to an aspect of the present disclosure.

### DETAILED DESCRIPTION

### Problem to be Solved by Present Disclosure

In recent years, there has been a marked increase in interest in environmental issues. For this reason, there is a need for electric wires with a reduced petroleum-derived resin material content in order to decrease the environmental load.

Therefore, the present disclosure is intended to provide an electric wire with a decreased the petroleum-derived resin material content.

### Effects of Present Disclosure

According to the present disclosure, an electric wire with a reduced resin material content can be provided.

The embodiments are described below.

### Description of Embodiments of Present Disclosure

First, embodiments of the present disclosure will be listed and described. In the following description, the same or corresponding elements are given the same reference numerals and the same descriptions thereof are not repeated.

(1) An electric wire according to an aspect of the present disclosure includes: a conductor; and an insulator that covers the conductor, wherein the insulator includes a resin material and a first filler, the insulator includes the first filler at a proportion of 10% by mass or more and 40% by mass or less, and the first filler is a chemical substance produced from a biological material.

When the insulator includes the first filler that is the chemical substance produced from the biological material, the content of petroleum-derived resin material can be reduced more than before. The first filler that is the chemical substance produced from the biological material, is not a non-renewable resource. Therefore, when the insulator includes the first filler and the content of the resin material is reduced, the environmental load can be decreased.

Because the first filler is the biological material, the carbon dioxide produced when the first filler is incinerated does not increase carbon dioxide in the atmosphere.

Therefore, the inclusion of the first filler in the insulator in turn results in a reduced amount of the resin material, and thus, even when the insulator part is incinerated when disposing and the like of the electric wire including the insulator, an increase in the amount of carbon dioxide in the atmosphere can be prevented. For this reason, the electric wire according to one aspect of the present disclosure can decrease the environmental load. Biological materials, such as, rice, corn,

shells, wood, and the like, may conceivably be used as the first filler without modification. However, when the biological materials are used as the first filler as they are, it is difficult to control the particle size, and dielectric breakdown may occur when a withstand voltage test is conducted. In addition, although the insulator may be famed by extrusion and the like, when the biological materials are used as the filler as they are, the first filler may become clogged in the molding machine during processing, and thereby productivity may be reduced.

Therefore, in the electric wire according to one aspect of the present disclosure, the chemical substance produced from the biological material may be used as the first filler. When the chemical substance produced from the biological material is used as the first filler, the particle size of the first filler can be easily controlled. Therefore, the productivity of the electric wire can be improved, and the biomass degree in the insulator and in the electric wire can be increased. In addition, the withstand voltage characteristics can be enhanced even when the insulator is thin.

When the insulator includes 10% by mass or more of the first filler, the biomass degree in the insulator and in the electric wire can be increased, and the amount of the resin material used can be reduced, thereby decreasing the environmental load. When the insulator includes 40% by mass or less of the first filler, the withstand voltage characteristics of the electric wire can be enhanced.

(2) In (1) described above, the first filler may contain starch.

Starch can be inexpensively produced from rice or corn, for example. That is, starch can be inexpensively produced from readily available biological materials. Therefore, when the first filler contains starch as the chemical substance, the productivity of the electric wire can be improved while reducing the production cost of the electric wire, and the biomass degree in the insulator and in the electric wire can be increased. In addition, the withstand voltage characteristics of the electric wire can be enhanced even when the insulator is thin.

(3) In (1) or (2) described above, the first filler may contain calcium carbonate.

Calcium carbonate can be inexpensively produced from oyster or scallop shells, for example. That is, calcium carbonate can be inexpensively produced from readily available biological materials. Therefore, when the first filler contains calcium carbonate as the chemical substance, the productivity of the electric wire can be improved while reducing the production cost of the electric wire, and the biomass degree in the insulator and in the electric wire can be increased. In addition, the withstand voltage characteristics of the electric wire can be enhanced even when the insulator is thin.

(4) In any of (1) to (3) described above, the first filler may contain cellulose.

Cellulose can be inexpensively produced from wood, for example. That is, cellulose can be inexpensively produced from readily available biological materials. Therefore, when the first filler contains cellulose as the chemical substance, the productivity of the electric wire can be improved while reducing the production cost of the electric wire, and the biomass degree in the insulator and in the electric wire can be increased. In addition, the withstand voltage characteristics of the electric wire can be enhanced even when the insulator is thin.

(5) In any of (1) to (4) described above, the resin material may be crosslinked.

When the resin material is crosslinked, the heat resistance, strength, and corrosion resistance of the electric wire can be enhanced.

(6) A multicore cable according to one aspect of the present disclosure includes: a plurality of electric wires twisted together, each electric wire of the plurality of electric wires being the electric wire of any of (1) to (5) described above; and a jacket that covers the plurality of electric wires.

According to one aspect of the present disclosure, because the multicore cable includes the electric wires according to one aspect of the present disclosure, it has high withstand voltage characteristics and excellent productivity even when the insulator included in the electric wire is thin, while decreasing the environmental load.

(7) In (6) described above, the jacket may include a second filler at a proportion of 10% by mass or more and 40% by mass or less, and the second filler may be a chemical substance produced from a biological material.

When the jacket includes 10% by mass or more of the second filler, the biomass degree in the jacket and in the multicore cable can be increased, and the amount of the resin material used can be reduced, thereby decreasing the environmental load. When the jacket includes 40% by mass or less of the second filler, the withstand voltage characteristics of the multicore cable can be enhanced.

### Details of Embodiments of Present Disclosure

Specific examples of the electric wire and the multicore cable in one embodiment of the present disclosure (hereinafter referred to as a “present embodiment”) are described below with reference to the drawings. The present invention is not limited to these examples, but is indicated by the scope of the claims and is intended to include all modifications within the meaning and scope of the claims and equivalents.

### Electric Wire

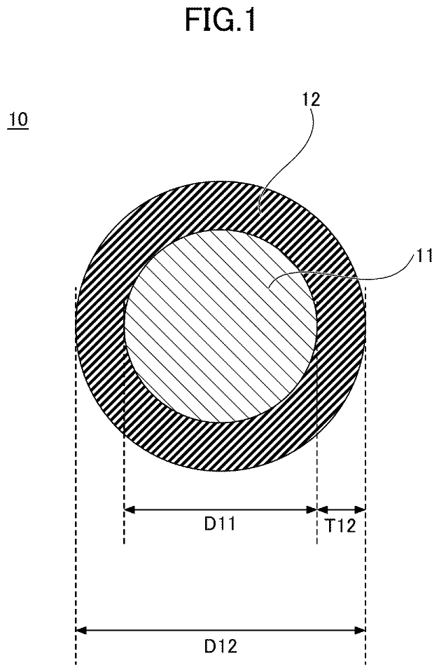

FIG. 1 illustrates the configuration example of a cross section perpendicular to the longitudinal direction of the electric wire of the present embodiment. In FIG. 1, the direction perpendicular to the paper surface is the longitudinal direction of the electric wire.

As illustrated in FIG. 1, an electric wire 10 of the present embodiment may include a conductor 11 and an insulator 12 that covers the conductor 11.

### (1) Component of Electric Wire

The components of the electric wire of the present embodiment will be described.

### (1-1) Conductor

The conductor 11 may include a single conductor strand or a plurality of conductor strands. When the conductor 11 includes a plurality of conductor strands, the conductor strands may be twisted. That is, when the conductor 11 includes a plurality of conductor strands, the conductor 11 may also be a twisted wire of the conductor strands.

The material of the conductor 11 is not particularly limited, but one or more conductor materials selected from, for example, copper alloy, copper, silver-plated soft copper, and tin-plated soft copper, may be used. As copper, soft copper may be suitably used.

The outer diameter D11 of the conductor 11 is not particularly limited, but is preferably 0.12 mm or more and 5.20 mm or less, for example. The cross-sectional area of the conductor 11 is not particularly limited, but is preferably 0.05 mm² or more and 8 mm² or less, for example.

### (1-2) Insulator

The insulator 12 may cover the outer surface of the conductor 11, specifically the outer surface along the longitudinal direction of the electric wire 10, as illustrated in FIG. 1. The insulator 12 may include a resin material and a first filler, as described below.

The outer diameter D12 of the insulator 12 is not particularly limited, but may be, for example, 0.2 mm or more and 8 mm or less.

### (1-2-1) Resin Material

The insulator 12 may include a resin material. The resin material is not particularly limited, but it is preferable to use one or more materials selected from, for example, polyolefin resin and polyvinyl chloride. The resin material may be a biomass-derived resin material, a biomass-derived polyolefin resin, and the like. By using the biomass-derived resin material as the resin material, the amount of the petroleum-derived resin material used can be reduced and the biomass degree in the insulator and in the electric wire can be increased.

In the present specification, the biomass degree means the mass percentage of the biomass-based material contained.

The polyolefin resin is not particularly limited. Examples of the polyolefin resin include polyethylene (PE); ethylene acrylate copolymers such as ethylene-vinyl acetate copolymers (EVA) and ethylene-ethyl acrylate copolymers (EEA); ethylene α-olefin copolymers, ethylene methyl acrylate copolymers, ethylene butyl acrylate copolymers, ethylene methyl methacrylate copolymers, ethylene acrylic acid copolymers, partially saponified EVAs, maleic anhydride modified polyolefins, ethylene acrylate maleic anhydride copolymers, and the like. The resins may be used alone or may be used as a mixture of two or more.

The resin material may or may not be crosslinked.

When the resin material is crosslinked, the heat resistance, strength, and corrosion resistance of the electric wire 10 can be enhanced. Therefore, when the electric wire 10 is used for applications requiring heat resistance, strength, and corrosion resistance, it is preferable that the resin material is crosslinked.

### (1-2-2) First Filler

The insulator 12 may include a first filler. As the first filler, a chemical substance produced from a biological material may be used.

When the insulator 12 includes the first filler that is the chemical substance produced from the biological material, the content of the petroleum-derived resin material can be reduced more than before. The first filler that is the chemical substance produced from the biological material, is not a non-renewable resource. Therefore, when the insulator 12 includes the first filler and the content of the resin material is reduced, the environmental load can be decreased.

Because the first filler is the biological material, the carbon dioxide produced when the first filler is incinerated does not increase the carbon dioxide in the atmosphere.

Therefore, the inclusion of the first filler in the insulator 12 in turn results in a reduced amount of the resin material, and thus, even when the insulator part is incinerated when disposing and the like of the electric wire including the insulator, an increase in the amount of carbon dioxide in the atmosphere can be prevented. For this reason, the electric wire according to the present embodiment can decrease the environmental load.

Biological materials, such as, rice, corn, shells, wood, and the like, may conceivably be used as the filler without modification. However, when the biological materials are used as the first filler as they are, it is difficult to control the particle size, and dielectric breakdown may occur when a withstand voltage test is conducted. In addition, although the insulator 12 may be formed by extrusion and the like, when the biological materials are used as the first filler as they are, the first filler may become clogged in the molding machine during processing, which may reduce productivity.

Therefore, in the electric wire according to the present embodiment, the chemical substance produced from the biological material may be used as the first filler. When the chemical substance produced from the biological material is used as the first filler, the particle size of the first filler can be easily controlled. Therefore, the productivity of the electric wire can be improved, and the biomass degree in the insulator 12 and in the electric wire 10 can be increased. In addition, the withstand voltage characteristics of the electric wire 10 can be enhanced even when the insulator 12 is thin.

The withstand voltage characteristics mean the characteristics that suppress the occurrence of pinholes and the like in the insulator 12 and that prevent the dielectric breakdown when a withstand voltage test is performed using a spark tester. Therefore, having excellent withstand voltage characteristics means that the insulation property of the insulator 12 is ensured.

The chemical substance produced from the biological material (hereinafter, also referred to simply as a “chemical substance”) is not particularly limited. The first filler may contain, as the chemical substance, for example, starch. The first filler may contain, as the chemical substance, for example, calcium carbonate. The first filler may also contain, as the chemical substance, for example, cellulose.

The first filler may contain a plurality of different chemical substances. The first filler may contain one or more substances selected from, for example, starch, calcium carbonate, cellulose, and the like.

Starch can be inexpensively produced from rice or corn, for example. Calcium carbonate can be produced inexpensively from oysters, scallops, or other shells, for example. Cellulose can be produced inexpensively from wood, for example. That is, starch, calcium carbonate, and cellulose can be inexpensively produced from readily available biological materials. Therefore, when the first filler contains one or more substances selected from starch, calcium carbonate, and cellulose, as the chemical substance, the productivity of the electric wire can be improved while reducing the production cost of the electric wire, and the biomass degree in the insulator 12 and in the electric wire 10 can be increased. In addition, the withstand voltage characteristics of the electric wire 10 can be enhanced even when the insulator 12 is thin.

The insulator 12 of the electric wire 10 in the present embodiment may include the first filler at a proportion of 10% by mass or more and 40% by mass or less. When the insulator 12 includes 10% by mass or more of the first filler, the biomass degree in the insulator 12 and in the electric wire 10 can be increased, and the amount of the resin material used can be reduced, thereby decreasing the environmental load. When the insulator 12 includes 40% by mass or less of the first filler, the withstand voltage characteristics of the electric wire 10 can be enhanced.

### (1-2-3) Additive

In addition to the resin material and the first filler above described above, the insulator 12 may also include various additives. The insulator 12 may include, for example, a flame retardant and the like, as the additive.

### Flame Retardant

The flame retardant is not particularly limited. As the flame retardant, either a halogen flame retardant or a non-halogen flame retardant may be used, but it is preferable to use the non-halogen flame retardant, especially from the viewpoint of decreasing the environmental load.

For this reason, the insulator 12 may include, as the flame retardant, for example, one or more flame retardants selected from phosphorus flame retardants; nitrogen flame retardants; metal hydroxides and metal oxides such as magnesium hydroxide, aluminum hydroxide, and antimony trioxide.

### Other Additives

The insulator 12 may include the resin material and the filler only, or may include the resin material, the filler, and the flame retardant only. However, the insulator 12 may further include additives. The insulator 12 may include, for example, antioxidants, deterioration inhibitors, colorants, crosslinking aids, tackifiers, lubricants, softeners, fillers, processing aids, coupling agents, and the like, which are commonly formulated in insulators.

Examples of the antioxidants include phenol-based antioxidants, amine-based antioxidants, sulfur-based antioxidants, phosphite ester-based antioxidants, and the like.

Examples of the deterioration inhibitors include hindered amine-based photostabilizers (HALS), ultraviolet absorbers, metal deactivators, hydrolysis inhibitors, and the like.

Examples of the colorants include carbon black, titanium white, other organic and inorganic pigments, and the like. These colorants may be added to the insulator 12 for identification or for ultraviolet absorption.

When the resin material of the insulator 12 is crosslinked, in order to increase the crosslinking efficiency, the crosslinking aid may be added at a proportion of 1 parts by mass or more and 10 parts by mass or less for 100 parts by mass of the resin material contained in the insulator 12. Examples of the crosslinking aid include triallyl isocyanurate, triallyl cyanurate, trimethylolpropane trimethacrylate, N, N′-methaphenylene bismaleimide, ethylene glycol dimethacrylate, zinc acrylate, zinc methacrylate, and the like.

Examples of the tackifiers include coumarone-indene resin, polyterpene resin, xylene formaldehyde resin, hydrogenated rosin, and the like. Examples of the lubricants include fatty acids, unsaturated fatty acids, their metal salts, fatty acid amides, fatty acid esters, and the like. Examples of the softeners include mineral oils, vegetable oils, plasticizers, and the like. Examples of the fillers include calcium carbonate, talc, clay, silica, zinc oxide, molybdenum oxide, and the like. As the coupling agent, a silane coupling agent, or a titanate-based coupling agent such as isopropyl triisostearoyl titanate, isopropyl tri(N-aminoethyl-aminoethyl) titanate, and the like, may be added, as required.

### Multicore Cable

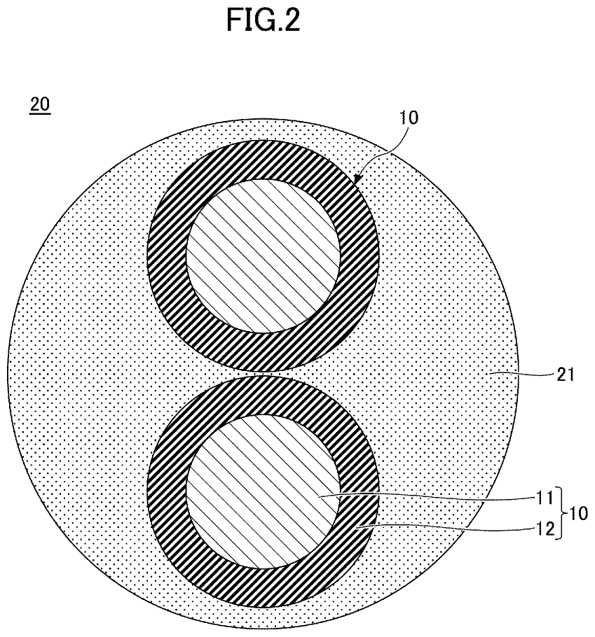

FIG. 2 illustrates the configuration example of a cross section perpendicular to the longitudinal direction of the multicore cable of the present embodiment. In FIG. 2, the direction perpendicular to the paper surface is the longitudinal direction of the multicore cable.

As illustrated in FIG. 2, a multicore cable 20 of the present embodiment may include a plurality of electric wires 10 twisted together and a jacket 21 that covers the electric wires 10.

### (1) Component of Multicore Cable

### (1-1) Electric Wire

As each of the electric wires 10 included in the multicore cable 20, the electric wire 10 according to the present disclosure already described may be used. Therefore, the description is omitted.

In FIG. 2, the multicore cable 20 includes two electric wires 10, but the number of the electric wires 10 included in the multicore cable 20 is not particularly limited. For example, three or more electric wires 10 may be included.

The multicore cable 20 may include a plurality of kinds of electric wires 10 with different configurations of outer diameters of the conductors 11 and the insulators 12, materials, and the like.

According to the present embodiment, because the multicore cable 20 includes the electric wires 10 according to an aspect of the present disclosure, it has high withstand voltage characteristics and excellent productivity even when the insulator 12 included in the electric wire 10 is thin, while decreasing the environmental load.

### (1-2) Jacket

A jacket 21 is provided to protect the electric wires 10 and can bind the electric wires 10 together. The composition of the jacket 21 is not particularly limited.

The jacket 21 may include a resin material and a second filler, as in the case of the insulator 12 of the electric wire 10 described above, for example.

As the resin material, the same material described with regard to the insulator 12 may be used suitably. Therefore, the description is omitted.

As the second filler, the same material as the first filler described with regard to the insulator 12 may be used suitably, and the chemical substance produced from the biological material may be used suitably. Therefore, the description of the second filler is omitted.

When the jacket 21 includes the second filler, the jacket 21 preferably includes the second filler at a proportion of 10% by mass or more and 40% by mass or less. When the jacket 21 includes 10% by mass or more of the second filler, the biomass degree in the jacket and in the multicore cable can be increased, and the amount of the resin material used can be reduced, thereby decreasing the environmental load. When the jacket 21 includes 40% by mass or less of the second filler, the withstand voltage characteristics of the multicore cable 20 can be enhanced.

### EXAMPLES

Specific examples are described below, but the present invention is not limited to these examples.

### Evaluation Method

First, the evaluation method of the electric wires produced in the following Experimental Examples is described.

### (1) Insulator Thickness

The outer diameter D11 of the conductor 11 and the outer diameter D12 of the insulator 12 were measured using a micrometer.

Specifically, in the case of the outer diameter D11 of the conductor 11, the outer diameters of the conductor 11 were measured by the micrometer along two orthogonal diameters of the electric wire 10 in any one cross section perpendicular to the longitudinal direction of the electric wire 10. The average value was then taken as the outer diameter D11 of the conductor 11 of the electric wire 10. The outer diameter D12 of the insulator 12 was also measured and calculated by the same procedure.

Then, the outer diameter D11 of the conductor 11 was subtracted from the outer diameter D12 of the insulator 12 and divided by 2 to obtain the insulator thickness T12.

In Table 1, in the row of “insulator thickness”, X denotes 0.2 mm, Y denotes 0.4 mm, and Z denotes 0.4 mm.

### (2) Withstand Voltage Test

The withstand voltage test using the spark tester was conducted. The case in which there was no conduction due to dielectric breakdown was evaluated as acceptable (“A”), and the case in which conduction due to dielectric breakdown was observed was evaluated as unacceptable (“B”).

The electric wires in Experimental Examples are described below.

Experimental Examples 1, 3 to 6 are examples, and Experimental Examples 2 and 7 are comparative examples.

### Experimental Example 1

In Experimental Example 1, an electric wire 10 including a conductor 11 and an insulator 12 that covers the conductor 11 was produced, as illustrated in FIG. 1 in a cross section perpendicular to the longitudinal direction.

### Conductor

As the conductor 11, a twisted wire in which 7 conductor strands of tin-plated soft copper wires having a wire diameter of 0.1 mm are twisted together, was used. The outer diameter D11 of the conductor 11 was 0.3 mm. The cross-sectional area of the conductor 11 is described in the row of “cross-sectional area” of conductor in Table 1.

### Insulator

Polyethylene (PE) as the resin material, and starch as the first filler, were supplied to an extruder, kneaded, and molded to cover the outer surface of the conductor 11 to form the insulator 12. In Table 1, the resin materials used in forming the insulator are described in the row of “resin material”, and the materials used as the first filler are described in the row of “filler”. In Experimental Example 1 and in Experimental Examples 3 to 7 described later, the chemical substances illustrated in Table 1 that were produced from biological materials were used as the materials for the first filler.

The resin material and the first filler were supplied to the extruder and kneaded so that the content of the first filler in the insulator 12 was the value described in the row of “filler amount” in Table 1. The obtained electric wire was irradiated with electron beams to crosslink the resin material contained in the insulator 12.

The obtained electric wire was subjected to the withstand voltage test. The evaluation results are illustrated in Table 1.

### Experimental Example 2

As the first filler, a crushed rice was used, which is not the chemical substance produced from the biological material but the biological material itself. Other than the above, the electric wire was produced and evaluated under the same conditions as in Experimental Example 1.

The evaluation results are illustrated in Table 1.

### Experimental Example 3 to Experimental Example 7

As the conductor 11, a twisted wire in which 50 conductor strands of tin-plated soft copper wires having a wire diameter of 0.45 mm are twisted together, was used. The outer diameter D11 of the conductor 11 was 3.7 mm.

The raw material was supplied to the extruder so that the resin material, the material of the first filler, and the mass percentage of the first filler contained in the insulator 12 had the values described in Table 1. PVC in Table 1 means polyvinyl chloride.

Other than the above, the electric wire was produced and evaluated under the same conditions as in Experimental Example 1.

The evaluation results are illustrated in Table 1.

TABLE 1

| | | EXPERI- | EXPERI- | EXPERI- | EXPERI- | EXPERI- | EXPERI- | EXPERI- |
|---|---|---|---|---|---|---|---|---|
| | | MENTAL | MENTAL | MENTAL | MENTAL | MENTAL | MENTAL | MENTAL |
| | | EXAMPLE | EXAMPLE | EXAMPLE | EXAMPLE | EXAMPLE | EXAMPLE | EXAMPLE |
| | | 1 | 2 | 3 | 4 | 5 | 6 | 7 |
| CON- | CROSS- | 0.05 | 0.05 | 8 | 8 | 8 | 8 | 8 |
| DUCTOR | SECTIONAL | | | | | | | |
| | AREA | | | | | | | |
| | (mm²) | | | | | | | |
| INSU- | RESIN | PE | PE | PE | PE | PE | PVC | PE |
| LATOR | MATERIAL | | | | | | | |
| | FILLER | STARCH | CRUSHED | STARCH | CALCIUM | CELLULOSE | STARCH | STARCH |
| | | | RICE | | CARBONATE | | | |
| | FILLER | 10 | 10 | 40 | 40 | 40 | 40 | 50 |
| | AMOUNT | | | | | | | |
| | (% BY MASS) | | | | | | | |
| | INSULATOR | X | X | Y | Y | Y | Y | Z |
| | THICKNESS | | | | | | | |
| EVALU- | WITHSTAND | A | B | A | A | A | A | B |
| ATION | VOLTAGE | | | | | | | |
| RESULT | TEST | | | | | | | |

What is claimed is:

1. An electric wire comprising:
a conductor; and
an insulator that covers the conductor, wherein
the insulator includes a resin material and a first filler,
the insulator includes the first filler at a proportion of 10% by mass or more and 40% by mass or less, and
the first filler is a chemical substance produced from a biological material.

2. The electric wire as claimed in claim 1, wherein the first filler contains starch.

3. The electric wire as claimed in claim 1, wherein the first filler contains calcium carbonate.

4. The electric wire as claimed in claim 1, wherein the first filler contains cellulose.

5. The electric wire as claimed in claim 1, wherein the resin material is crosslinked.

6. A multicore cable comprising:
a plurality of electric wires twisted together, each electric wire of the plurality of electric wires being the electric wire according to claim 1; and
a jacket that covers the plurality of electric wires.

7. The multicore cable as claimed in claim 6, wherein
the jacket includes a second filler at a proportion of 10% by mass or more and 40% by mass or less, and
the second filler is a chemical substance produced from a biological material.
